(19) United States
(12) Patent Application Publication
(10) Pub. No.: US 2004/0161582 A1
(43) Pub. Date: Aug. 19, 2004

(54) Method for preparing poly (trimethylene terephthalate) carpet

(75) Inventors: Kyool Seop Lee, Gunpo-Shi (KR); Young Chan Choi, Seol (KR); Jong Bok Lee, Anyang-Shi (KR)

Correspondence Address: FISH & RICHARDSON PC, 225 FRANKLIN ST, BOSTON, MA, 02110, US

(73) Assignee: Hyosung Corporation, a Korea corporation

(21) Appl. No.: 10/777,319

(22) Filed: Feb. 12, 2004

Related U.S. Application Data
(62) Division of application No. 10/077,310, filed on Feb. 15, 2002.

(30) Foreign Application Priority Data
May 14, 2001 (KR) 2001-26144

(51) Int. Cl. B32B 33/00; D02G 3/02; D02G 3/28; D05C 15/04; D06P 3/54; D06C 13/00

(52) U.S. Cl. 428/97; 8/929; 26/15 R; 57/237

(57) ABSTRACT

Disclosed is a method for preparing a poly(trimethylene terephthalate) carpet, in which the poly(trimethylene terephthalate) carpet is prepared from poly(trimethylene terephthalate) yarns through the post-processes comprising cabling, heat setting, tufting, dyeing, becking, and shearing. The poly(trimethylene terephthalate) yarns have advantages of improved quality, functionality, and workability by optimizing operating conditions of the steps.

### BACKGROUND OF THE INVENTION

1. Field of the Invention

The present invention relates, in general, to a method for preparing a poly(trimethylene terephthalate) (PTT) carpet, and in particular, to a method for preparing a poly(trimethylene terephthalate) carpet whose quality, functionality, and workability are improved by optimizing processing conditions of the post-processes comprising cabling, heat setting, tufting, dyeing, becking, and shearing.

2. Description of the Prior Art

Carpets which are resistant to staining by common food dyes are currently in high demand. In order to be stain-resistant, nylon carpets must either be treated with a stain-resist chemical or the nylon fibers must have a stain-resist agent incorporated within the polymer.

In addition, carpets made from polyester fibers which have excellent stain-resistance, such as poly(ethylene terephthalate) or poly(butylene terephthalate), have been developed. For example, U.S. Pat. Nos. 3,998,042 and 4,877,572 disclose a process for preparing a poly(ethylene terephthalate). BCF yarn, in which carpets made from the poly(ethylene terephthalate) BCF yarn have good stain-resistance, but exhibit poor pile recovery owing to low elastic recovery and poor texture retention, and so the poly(ethylene terephthalate) BCF yarn is hardly used nowadays.

To improve disadvantages of the above poly(ethylene terephthalate) carpet, a technology for preparing a carpet from a poly(trimethylene terephthalate). BCF yarn has been developed. For example, U.S. Pat. No. 5,662,980 discloses carpets made from poly(trimethylene terephthalate) bulked continuous filament modified cross-section yarn, in which poly(trimethylene terephthalate) bulked continuous filament modified cross-section yarns used to produce a carpet have excellent stain-resistance, as well as good bending recovery and pile height retention. In addition, the carpet made from poly(trimethylene terephthalate) BCF modified cross-section yarns has good texture retention.

However, the above invention has disadvantages in that, because spin finishes are coated after a supplying roller, a large friction is exerted on the threads passing through the supplying roller, resulting in many yarn cuttings and thus poor workability. Another disadvantage results from the yarn condensing which should be conducted at high temperatures by a condensing device with concurrent operation of a bulking device. Thus, yarns are so poorly condensed that the piles are excessively frayed during the post-processes, and the carpet is poor in appearance.

Also, according to U.S. Pat. No. 5,662,980, only a main tunnel temperature among various factors with respect to a heat treatment step is specified, but other factors such as retention time in the main tunnel and a density of a grey yarn on a band are not specified, thereby an optimum heat treatment cannot be accomplished.

### SUMMARY OF THE INVENTION

Therefore, it is an object of the present invention to avoid disadvantages of prior arts, and to provide a method for preparing a poly(trimethylene terephthalate) carpet whose quality, functionality, and workability are improved by optimizing processing conditions of the post-processes comprising cabling, heat setting, tufting, dyeing, becking, and shearing.

It is another object of the present invention to provide a method for preparing a poly(trimethylene terephthalate) carpet which is identical or superior to conventional carpets in physical properties including peeling strength, drawing strength, and dimensional stability, as well as showing excellent post-process workability.

To accomplish the above objects, the present invention provides a method for preparing a poly(trimethylene terephthalate) carpet, comprising the steps of:

(A) cabling poly(trimethylene terephthalate) yarns;

(B) heat-setting twisted poly(trimethylene terephthalate) yarns with a density of 200 to 240 g/m by use of a Superba at a main tunnel temperature of 120 to 160° C. and a band speed of 4 to 9 m/min;

(C) tufting heat-set poly(trimethylene terephthalate) yarns at 5 to 15 stitches/inch;

(D) beck-dyeing a tufted carpet without carriers by use of a disperse dye under conditions of atmospheric pressure and a dyeing temperature of 90 to 100° C.;

(E) becking a dyed carpet; and

(F) shearing the resulting carpet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an modification ratio and a arm angle of a poly(trimethylene terephthalate) carpet modified cross-section yarn according to the present invention;

FIG. 2 schematically illustrates a production of a poly(trimethylene terephthalate) carpet modified cross-section yarn according to the present invention;

FIG. 3 is a flow chart schematically illustrating a production of a poly(trimethylene terephthalate) carpet according to the present invention.

### DETAILED DESCRIPTION OF THE INVENTION

A carpet of the present invention is produced from poly(trimethylene terephthalate) yarns. The carpet has excellent resiliency, stain-resistance, and dyeing property to disperse dye, and also has excellent elastic recovery and pile height retention in comparison with a poly(ethylene terephthalate) carpet or a poly(butylene terephthalate) carpet. Accordingly, the poly(trimethylene terephthalate) carpet according to the present invention is useful as a high quality carpet for use in home or office. Furthermore, the carpet of the present invention can be applied to produce a cut pile style carpet, a loop pile style carpet, a combination style carpet, a mat, and a carpet.

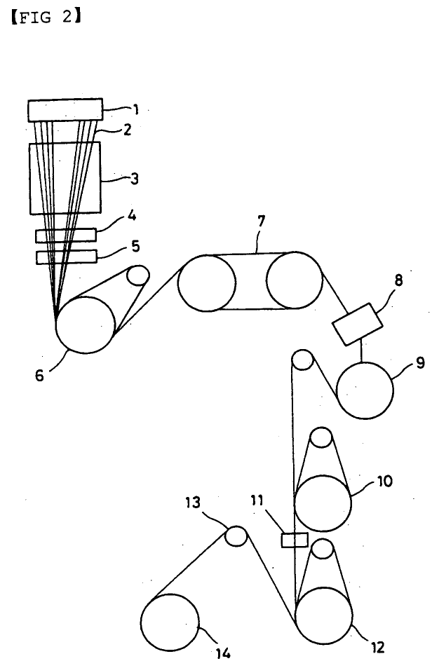

With reference to FIG. 2, poly(trimethylene terephthalate) modified cross-section yarns used to prepare the carpet of the present invention are produced as follows:

PTT polymer with an intrinsic viscosity of 0.8 to 1.2 and a moisture content of 50 ppm or less is melt-spun at 245 to 265° C. through a spinning nozzle 1. The nozzle has a Y-shaped cross-section, 40 holes or more, a modification ratio of 1.5 to 3.5, and an arm angle of 5 to 40°. When the modification ratio and the arm angle are within the above ranges, PTT yarns have excellent bulk property, spinning efficiency, and tufting efficiency.

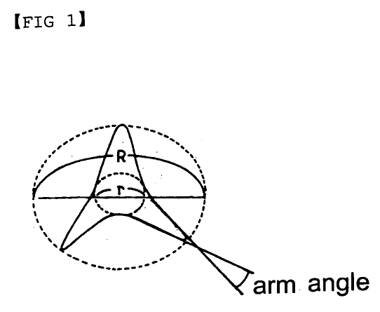

With reference to FIG. 1, ‘modification ratio’ means a ratio of a diameter R of a circumscribed circle to a diameter r of an inscribed circle of one filament in grey yarns with a Y-shaped cross section, i.e. modification ratio=R/r, and ‘arm angle’ means an acute angle formed by two lines extended from both edges of one arm of a filament in grey yarns with a Y-shaped cross section.

Then, spun filaments 2 moving at a speed of 0.4 to 0.6 m/min are cooled at 10 to 25° C. in a cooling zone 3, and subjected to a spin finish step, in which cooled yarns are oiled with the use of a knit type oiling agent or a water soluble oiling agent through two phases in a finish applicator 4, so that lubrication property, and smoothness of yarns are increased and yarns are highly condensed.

After that, the resulting yarns are passed through a nozzle 5 for inhaling yarns which inhales snapped threads generated during the spinning, and drawn by use of a supplying roller 6 at a rate of 650 to 850 m/min and a temperature of 45 to 80° C. and a drawing roller 7 at a rate of 1500 to 4000 m/min and a temperature of 140 to 180° C. Filaments are crimped at 180 to 220° C. under 5 to 8 kg/m² through a bulking unit 8 with a texturing nozzle after filaments are passed through the drawing roller 7, and crimp is 10 to 60%.

Next, filaments are cooled through a cooling drum 9 at 15 to 22° C., and twists and knots of 10 to 40 times/m are endowed to yarns under 4.5 to 5.0 kg/m² through a whirling machine 11 via a godet roller 10, and so yarns are highly condensed. When whirling of 10 times/m or less is endowed to yarns, problems of fluffiness or capillaries occur because a grey yarn is poorly condensed, and so cutting efficiency of the grey yarn is reduced during the tufting, thereby a sheared carpet has a bad appearance because the edges of pile are frayed, and a bearing strength of the carpet is also lowered.

On the other hand, if filaments are whirled at 40 times/m or more, the carpet is poor in appearance because the filaments remain knotted even after dyeing and post-processing. Thereafter, yarns are wound with the use of a wind-up machine 14 via a fifth godet roller 12 and a yarn guide 13. A speed of the wind-up machine 14 is determined according to the speed of the fifth godet roller 12, and preferably. 1400 to 3500 m/min.

The poly(trimethylene terephthalate) carpet of the present invention may be produced from a dope dyed yarn according to uses of the carpet. Generally, the dope dyed yarn has excellent stain-resistance and resistance to wear, and can be applied to carpets for use in an office. But, carpets subjected to a piece dyeing can be suitably applied to high quality carpets for using in home or hotel.

A method for preparing a carpet from poly(trimethylene terephthalate) dope dyed yarns according to the present invention is the same as the method for preparing a carpet from general poly(trimethylene terephthalate) yarns as described above, except that a color master batch of 2 to 5% based on a base chip is blended with raw materials, and they are spun. The carpet thus produced has more excellent color fastness to washing, color fastness to light, and color fastness to rubbing than the carpet subjected to piece dyeing, and a defective proportion is low because streaking hardly occurs.

The poly(trimethylene terephthalate) yarns of the present invention are subjected to post-processes such as cabling, heat setting, tufting, dyeing, becking, and shearing to prepare a carpet.

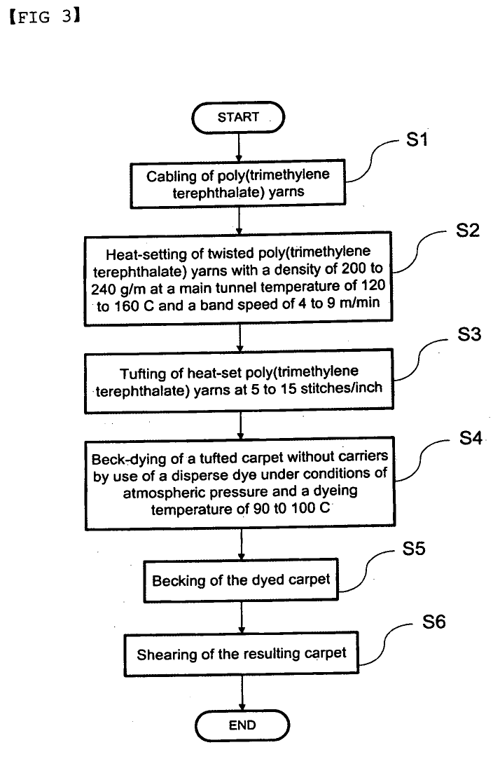

Turning now to FIG. 3, in which a flow chart schematically illustrates a production process of the poly(trimethylene terephthalate) carpet according to the present invention.

Yarns are twisted in the step of cabling (S1). With the use of a cable twister, the yarns are S- or Z-twisted at 180 to 250 twists/m to two- or three-ply cables. In this case, the RPM of the twister is preferably in the range of 4000 to 4300.

Next, the twisted yarns are heat set (S2). Generally, a heat setting device may be Autoclave, Seussen, or Superbar. According to the present invention, Superbar is used. The twisted yarns with a density of 200 to 240 g/m are preferably heat set at a main tunnel temperature of 120 to 160° C. and a band speed of 4 to 9 m/min with the use of steam.

For example, when the temperature is less than 120° C., the edges of pile are readily frayed to give a poor appearance because yarns are not sufficiently heat set although bulk property is good. On the other hand, at a temperature higher than 16° C., the bulk property becomes too low to represent rich volume sense in the carpet. Furthermore, when the band speed and the density deviate from the above range, physical properties of heat set yarns are poor.

The step of heat setting may further comprise Frieze-processing before setting with the use of steam, thereby the carpet has a three-dimensional appearance and two different colors effect having a positive aesthetic appeal, and also setting property and resistance to wear of pile are increased, as well as volume sense is improved.

Meanwhile, yarns may be twisted to two- or three-ply cables with the use of an intermingle machine at 400 to 1000 m/min under 4 to 8 bar according to uses of carpets. After that, the yarns are tufted without heat setting.

Then, heat-set yarns are planted on a PET spun bond or PP foundation cloth with the use of a tufting machine of ⅛, 5/32, and 1/10 gauge (S3). A range of stitch is 5 to 15 stitches/inch. A pile height ranges from 4 to 18 mm for a cut pile style carpet and from 2.5 to 15 mm for a loop pile style carpet. A weight of the grey yarn used to produce a carpet ranges from 10 to 90 oz/yd².

For example, the weight and volume sense are poor at 5 stitches/inch or less. On the other hand, at 15 stitches/inch or more, drawing and peeling strengths are drastically reduced because yarns are not uniformly adhered to the foundation cloth during becking.

Next, a tufted carpet is beck dyed without carriers by use of a disperse dye under conditions of atmospheric pressure and a dyeing temperature of 90 to 10° C.(S4). For example, when the temperature is less than 90° C., the carpet with desirable colors cannot be prepared because yarns are thin dyed. On the other hand, when the temperature is more than 100° C., a production cost is increased because yarns should be dyed under a high pressure. OWF (an amount of an added dye based on the carpet) is 0.01 to 3.0%, a liquid ratio is 10:1 to 25:1, and an amount of a dispersing agent ranges from 0.25 to 1.0 g/l.

Another dyeing method, space dyeing, may be used, in which poly(trimethylene terephthalate) yarns are dyed with the use of a MCD (multi color dyeing) machine in a single color or in six or fewer colors before heat-setting.

In the step of becking (S5), the dyed carpet is beck coated with latex so that piles do not came off, followed by being adhered to a second foundation cloth such as jute and polypropylene foundation cloth, and PVC or SBS (styrene butadiene styrene) is used as an auxiliary mat, i.e. a becking reinforcement. Latex comprises solids of 80%, in detail, base latex of 30 to 50%, CaCO₃ of 50 to 70%, dispersing agent, and viscosity enhancing agent. To increase a reserve effect, small amount of Al₂O₃ or Al₂OH₃ may be added to latex.

To improve appearance of piles, piles are uniformly trimmed with the use of a spiral knife in the final step of shearing (S6).

A poly(trimethylene terephthalate) carpet according to the present invention has excellent appearance, sense of touch, resistance to wear, and elastic recovery, which are advantages of nylon, as well as good stain-resistance and electrostatic resistance, which are advantages of polyester.

Furthermore, the poly(trimethylene terephthalate) carpet according to the present invention has compressibility of 30% or more, compressive resilience of 90% or more, pile yarns with drawing strength of 2.0 kg or more, bonded fabric with peeling strength of 2.0 kg or more, and color fastness to washing, color fastness to rubbing, and color fastness to light of 4 grade or more. Accordingly, the poly(trimethylene terephthalate) carpet according to the present invention is useful as a high quality carpet for use in home or office.

### EXAMPLES AND COMPARATIVE EXAMPLES

A better understanding of the present invention may be obtained in light of the following examples which are set forth to illustrate, but are not to be construed to limit the present invention.

<Test Methods of Carpet>

(1) Pencil Point

Pencil point was estimated in three grades, i.e. A: good, B: medium, C: bad, by observing with the naked eye a degree that the edges of pile was frayed;

(2) Color Fastness to Rubbing

Color fastness to rubbing was estimated according to KS K 0650;

(3) Appearance

Colors, luster, volume sense, sense of touch of carpets were estimated in four grades, i.e. AA: very good, A: good, B: medium, C: bad;

(4) Drawing Strength

Drawing strength was estimated according to KS K 0818;

(5) Peeling Strength

Peeling strength was estimated according to KS K 0818;

(6) Compressibility/Compressive Resilience

A ratio of compressibility/compressive resilience was tested according to A of KS K 0818;

(7) Color Fastness to Light

The carpet was treated at 63° C. for 40 hours, and tested according to KS K 0700. Then, color fastness to light was estimated by use of ISO blue scale;

(8) Color Fastness to Washing

The carpet was treated at 40° C., and tested according to A-1 of KS K 0430;

(9) Streak Property

Streak property was estimated in three grades, i.e. A: good, B: medium, C: bad, by the naked eye.

### Example 1

PTT polymer with a moisture regain of 40 ppm and an intrinsic viscosity of 0.92 was melt-spun at 250° C. with the use of a nozzle having a Y-shaped cross section, 68 holes, a modification ratio of 2.0, and an arm angle of 33° in a barmag spinning machine, which could produce three tons of spun yarns per day, to produce 68 filaments of 1300 deniers. Then, the resulting filaments were cooled to 16° C. in a cooling zone, at a velocity of 0.5 m/min. After that, the cold filaments were drawn by use of a supplying roller with a temperature of 60° C. and a speed of 700 m/min, and a drawing roller with a temperature of 160° C. and a speed of 2300 m/min.

Drawn yarns were crimped at 20° C. in a bulking unit, cooled to 16° C. in a cooling drum, and twists of 20 times/m were endowed to cooled yarns under 4.0 kg/m² in a condensing device. Then, the resulting yarns were finally wound at 1950 m/min to produce poly(trimethylene terephthalate) BCF modified cross-section yarns.

With the use of a cable twister, the resulting BCF yarns were Z-twisted at 194 twists/m, followed by heat-setting the twisted yarns by a Superba unit. Twisted yarns with a density of 240 g/m were heat set at a main tunnel temperature of 138° C. and a band speed of 5.14 m/min (6 m/70 sec). The heat-set yarns were then planted on polypropylene foundation cloth with the use of a tufting machine with a 1/10 gauge. The pile was of a cut pile style with a height of 12 mm, 13 stitches/inch, and a grey yarn weight of 4 kg/3.3 m².

A tufted carpet was beck-dyed without carriers by use of a disperse dye DIANIX combi under conditions of atmospheric pressure, a dyeing temperature of 98° C., a dispersing agent of 0.5 μl, OWF (an amount of an added dye based on the carpet) of 0.01%, and a liquid ratio of 20:1.

The dyed carpet was coated with a mixture of base latex of 35%, CaCO₃ of ˜60%, dispersing agent, and viscosity enhancing agent, followed by being adhered to a second foundation cloth, i.e. jute, and finally sheared with the use of a spiral knife. The resulting carpet was evaluated in terms of appearance, pencil point, and color fastness to rubbing. The results are described in Table 2.

### Examples 2 to 3

The procedure of example 1 was repeated except that a main tunnel temperature, a band speed, and a density of a grey yarn were varied as described in Table 1. The resulting carpet was evaluated in terms of physical properties. The results are described in Table 2.

### Comparative Examples 1 to 4

To compare physical properties of the carpets varied according to heat setting conditions, grey yarns according to example 1 were heat set under operating conditions as described in Table 1, below. After that, heat-set yarns were subjected to tufting, dyeing, becking, and shearing step in the same manner as example 1 to produce a carpet. The resulting carpet was evaluated in terms of physical properties, and the results are described in Table 2.

TABLE 1

| Example No. | Main tunnel temp. (° C.) | Band speed | ¹Density (g/m) |
|---|---|---|---|
| 2 | 138 | 9 m/70 sec | 240 |
| C. 1 | 138 | 6 m/70 sec | 300 |
| 3 | 125 | 6 m/70 sec | 240 |
| C. 2 | 170 | 6 m/70 sec | 240 |
| C. 3 | 138 | 4 m/70 sec | 240 |
| C. 4 | 138 | 6 m/70 sec | 180 |
| 1 | 138 | 6 m/70 sec | 240 |

¹Density of a grey yarn on a band

TABLE 2

| | | Pencil | Color fastness |
|---|---|---|---|
| Example | Appearance | point | to rubbing |
| No | (grade) | (grade) | (grade) |
| 2 | AA | A | 4 |
| C. 1 | A | B | 3 |
| 3 | AA | A | 4 |
| C. 2 | B | A | 5 |
| C. 3 | A | B | 4 |
| C. 4 | B | A | 5 |
| 1 | AA | A | 5 |

The carpet of example 1 had excellent appearance and color fastness to rubbing of grade 5, and the edges of pile were not frayed. On the whole, carpets according to examples 2 and 3 also had excellent physical properties.

The carpet of comparative example 1, however, with a short thermal history had a low heat-set property and could hardly endure friction. Also, the edges of pile were readily frayed. On the other hand, a carpet with a long thermal history as in comparative examples 2 and 3, had a very high heat-set property and low bulk property and poor sense of touch, as well as bad appearance owing to poor dyeing property.

### Example 5 and Comparative Examples 5 to 6

To test drawing and peeling strengths of piles varied according to an interval between stitches during tufting, the exact procedure of example 1 was repeated in example 5. In case of comparative examples 5 and 6, the procedure of example 1 was repeated except that heat-set yarns were planted on polypropylene foundation cloth at 3 stitches/inch and 20 stitches/inch, respectively.

The resulting poly(trimethylene terephthalate) carpet was evaluated in terms of physical properties, and the results are described in Table 3.

TABLE 3

| Example | Stitch | Drawing strength | Peeling strength | Appearance |
|---|---|---|---|---|
| No. | (/in) | (Dry) (kg) | (Length) (kg) | (grade) |
| C. 5 | 3 | 1.5 | 1.3 | A |
| C. 6 | 20 | 3.2 | 3.0 | C |
| 5 | 13 | 3.6 | 3.3 | AA |

In case of comparative example 5, adhesives were not sufficiently coated to the carpet during becking because the interval between stitches was too narrow, and so drawing and peeling strengths were lowered. Also, at 20 stitches/inch as described in comparative example 6, appearance properties such as weight, sense of density, and sense of touch were very poor although drawing and peeling strengths were not bad.

### Example 6

The procedure of example 1 was repeated except that a color master batch of 3% based on a PTT base chip was supplied to raw materials in order to produce a poly(trimethylene terephthalate) dope dyed yarn, thereby a carpet was produced.

The carpet made from poly(trimethylene terephthalate) dope dyed yarns according to example 3 was compared to the carpet according to example 1 in physical properties. The results are described in Table 4.

TABLE 4

| | Compressibility | Compressive | ¹Color | |
|---|---|---|---|---|
| Example No. | (%) | Resilience (%) | fast. | Streak property |
| 1 | 46 | 96 | 4, 4, 5 | A |
| 3 | 40 | 94 | 5 all | A |

¹Color fastnesses to washing, light, and rubbing (grades)

The dope dyed BCF carpet of example 6 had more excellent color fastness to washing, color fastness to light, and color fastness to rubbing than the carpet subjected to a piece dyeing, and had slightly better streak property than example 1, so that dyed appearance of the dope dyed carpet was better than that of the general carpet. But, the dope dyed carpet was slightly poor in compressibility and compressive resilience because a dyeing step was absent and a growth of a latent bulk owing to the dyeing step was also absent. However, compressibility and compressive resilience of the dope dyed carpet according to the present invention were better than those of nylon or poly(ethylene terephthlate) carpet.

As described above, the present invention provides a poly(trimethylene terephthalate) carpet having excellent appearance, sense of touch, resistance to wear, elastic recovery, stain-resistance, electrostatic resistance, as well as peeling strength, drawing strength, and dimensional stability. Furthermore, the method for preparing poly(trimethylene terephthalate) carpet according to the present invention has an advantage of excellent post-process efficiency.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for preparing a poly(trimethylene terephthalate) carpet, comprising the steps of:
(A) cabling poly(trimethylene terephthalate) yarns;
(B) heat-setting twisted poly(trimethylene terephthalate) yarns with a density of 200 to 240 g/m by use of a Superba at a main tunnel temperature of 120 to 160° C. and a band speed of 4 to 9 m/min;
(C) tufting heat-set poly(trimethylene terephthalate) yarns at 5 to 15 stitches/inch;
(D) beck-dyeing a tufted carpet without carriers by use of a disperse dye under conditions of atmospheric pressure and a dyeing temperature of 90 to 100° C.;
(E) becking a dyed carpet; and
(F) shearing the resulting carpet.

2. The method according to claim 1, wherein poly(trimethylene terephthalate) dope dyed yarns are used.

3. The method according to claims 1 or 2, wherein the cabling step is carried out by Z-twisting the yarns at 180 to 250 twists/m to a two- or three-ply cable.

4. The method according to claims 1 or 2, comprising the step of condensing poly(trimethylene terephthalate) yarns with the use of an intermingle machine at 400 to 1000 m/min under a air pressure of 4 to 8 bars without a heat-setting step.

5. The method according to claims 1 or 2, further comprising the step of frieze processing before heat-setting.

6. The method according to claims 1 or 2, wherein a pile height ranges from 4 to 18 mm for a cut pile style carpet and from 2.5 to 15 mm for a loop pile style carpet.

7. The method according to claims 1 or 2, wherein the tufted carpet is dyed under conditions of OWF (an amount of an added dye based on the carpet) of 0.01 to 3%, a liquid ratio of 10:1 to 25:1, and a dispersing agent of 0.25 to 1.0 g/l.

8. The method according to claims 1 or 2, further comprising the step of space dyeing the poly(trimethylene terephthalate) yarns in a single color or in six or fewer colors with the use of a multi color dyeing machine before the heat-setting step.

9. The method according to claims 1 or 2, wherein said dyed carpet is coated with a latex composition consisting of base latex of 30 to 50%, CaCO₃ of 50 to 70%, dispersing agent, and viscosity enhancing agent, followed by being adhered to a second foundation cloth in the step of becking.

10. The method according to claims 1 or 2, wherein the poly(trimethylene terephthalate) carpet is prepared from poly(trimethylene terephthalate) yarns spun through a nozzle having 40 or more holes with a Y-shaped cross section, a modification ratio of 1.5 to 3.5, and an arm angle of 5 to 40° C.

11. A poly(trimethylene terephthalate) carpet prepared by the method according to claim 1, having pile yarns with drawing strength of 2.0 kg or more, bonded fabric with peeling strength of 2.0 kg or more, and color fastness to washing, color fastness to rubbing, and color fastness to light of grade 4 or more with respect to Korean Industrial Standards.
